(19) United States
(12) Patent Application Publication
(10) Pub. No.: US 2020/0279006 A1
(43) Pub. Date: Sep. 3, 2020

(54) INFORMATION PROCESSING APPARATUS, INFORMATION PROCESSING METHOD, AND PROGRAM

(71) Applicant: SONY CORPORATION, TOKYO (JP)

(72) Inventors: MITSUHIRO MIYAZAKI, KANAGAWA (JP); SHIMON SAKAI, KANAGAWA (JP); KAZUNORI ARAKI, TOKYO (JP); SHOSUKE MOMOTANI, KANAGAWA (JP)

(21) Appl. No.: 16/646,180

(22) PCT Filed: Aug. 16, 2018
(86) PCT No.: PCT/JP2018/030438

§ 371 Date: Mar. 11, 2020

(30) Foreign Application Priority Data
Nov. 17, 2017 (JP) 2017-221977

(51) Int. Cl. G06F 16/9535; G06F 16/9538; G06F 16/2457; G06F 16/9537

(52) U.S. Cl. CPC G06F 16/9535; G06F 16/9537; G06F 16/24578; G06F 16/9538

(57) ABSTRACT

More beneficial recommendation information at a timing suitable for a state of the user is provided. There is provided an information processing apparatus including a presentation control unit configured to control presentation of recommendation information to a user on the basis of a recommendation score regarding content, in which the presentation control unit controls presentation of the recommendation information further on the basis of an acceptability score calculated from matching between a content situation regarding the content and a user situation regarding the user. Further, there is provided an information processing method including causing a processor to control presentation of recommendation information to a user on the basis of a recommendation score regarding content, in which the causing a processor to control presentation further includes controlling presentation of the recommendation information on the basis of an acceptability score calculated from matching between a content situation regarding the content and a user situation regarding the user.

### TECHNICAL FIELD

The present disclosure relates to an information processing apparatus, an information processing method, and a program.

### BACKGROUND ART

In recent years, there have been widely used various apparatuses that present recommendation information to a user on the basis of the user's taste or the like. For example, Patent Document 1 discloses a technology of recommending content to the user on the basis of a use history of the user regarding services.

### CITATION LIST

### Patent Document

Patent Document 1: Japanese Patent Application Laid-Open No. 2015-35140

### SUMMARY OF THE INVENTION

### Problems to be Solved by the Invention

By the way, in the recommendation technology described above, a timing at which the recommendation information is presented to the user is important. However, the technology disclosed in Patent Document 1 does not consider the above timing. Thus, it is expected that the recommendation information may not be sufficiently used.

In view of this, the present disclosure proposes an information processing apparatus, an information processing method, and a program, each of which is new, is improved, and is capable of presenting more beneficial recommendation information at a timing suitable for a state of a user.

### Solutions to Problems

According to the present disclosure, there is provided an information processing apparatus including a presentation control unit configured to control presentation of recommendation information to a user on the basis of a recommendation score regarding content, in which the presentation control unit controls presentation of the recommendation information further on the basis of an acceptability score calculated from matching between a content situation regarding the content and a user situation regarding the user.

In addition, according to the present disclosure, there is provided an information processing method including causing a processor to control presentation of recommendation information to a user on the basis of a recommendation score regarding content, in which the causing a processor to control presentation further includes controlling presentation of the recommendation information on the basis of an acceptability score calculated from matching between a content situation regarding the content and a user situation regarding the user.

In addition, according to the present disclosure, there is provided a program for causing a computer to function as an information processing apparatus including a presentation control unit configured to control presentation of recommendation information to a user on the basis of a recommendation score regarding content, in which the presentation control unit controls presentation of the recommendation information further on the basis of an acceptability score calculated from matching between a content situation regarding the content and a user situation regarding the user.

### Effects of the Invention

As described above, the present disclosure can present more beneficial recommendation information at a timing suitable for a state of a user.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is an explanatory diagram of an overview of an embodiment of the present disclosure.

FIG. 2 is a block diagram illustrating a system configuration example of an information processing system according to this embodiment.

FIG. 3 is a block diagram illustrating a functional configuration example of an information processing terminal according to this embodiment.

FIG. 4 is a block diagram illustrating a functional configuration example of an information processing server according to this embodiment.

FIG. 5 is a block diagram illustrating a functional configuration example of a presentation control unit according to this embodiment.

FIG. 6 illustrates an example of a data structure of spot analysis information according to this embodiment.

FIG. 7 illustrates an example of a data structure of spot analysis information according to this embodiment.

FIG. 8 is an explanatory diagram of calculation of acceptability for each situation attribute according to this embodiment.

FIG. 9 is an explanatory diagram of situational reasons according to this embodiment.

FIG. 10 illustrates an example of a data structure of a user history according to this embodiment.

FIG. 11 is a flowchart showing a flow of calculating a recommendation score according to this embodiment.

FIG. 12 is a flowchart showing a flow of acquiring a recommendation result based on a wish list according to this embodiment.

FIG. 13 is a flowchart showing a flow of calculating an acceptability score according to this embodiment.

FIG. 14 illustrates a specific example of calculating acceptability scores according to this embodiment.

FIG. 15 illustrates a specific example of calculating acceptability scores according to this embodiment.

FIG. 16 is a flowchart showing a flow of presenting recommendation information and acquiring a user history regarding a situational reason according to this embodiment.

FIG. 17 illustrates an example of recommendation information according to this embodiment.

FIG. 18 is an explanatory diagram of presentation of recommendation information to a user individual or a user group according to this embodiment.

FIG. 19 is a diagram illustrating an example of a hardware configuration according to an embodiment of the present disclosure.

### MODE FOR CARRYING OUT THE INVENTION

Hereinafter, a preferred embodiment of the present disclosure will be described in detail with reference to the appended drawings. Note that, in this specification and the appended drawings, structural elements that have substantially the same function and configuration are denoted with the same reference numerals, and repeated explanation of these structural elements is omitted.

Note that description will be provided in the following order.

1. First embodiment

1.1. Overview

1.2. System configuration example

1.3. Functional configuration example of information processing terminal 10

1.4. Functional configuration example of information processing server 20

1.5. Flow of operation

1.6. Recommendation to user individual or user group

2. Hardware configuration example

3. Conclusion

### 1. FIRST EMBODIMENT

### 1.1. Overview

First, an overview of an embodiment of the present disclosure will be described. As described above, in recent years, there have been widely used various apparatuses that present recommendation information to a user. The above apparatuses can make recommendations regarding products, services, events, vacation spots, and the like on the basis of, for example, the user's taste or the like.

Meanwhile, in presenting the recommendation information, a timing at which a recommendation is made to the user is extremely important. For example, in recommending a vacation spot to the user, in a case where another vacation spot is recommended while the user is being on a trip or immediately after the user comes home, it is expected that an effect of recommendation may be poor for the user who is satisfied with the most recent trip, even though the vacation spot matches the user's taste.

Meanwhile, for example, in a case where a vacation spot is recommended at a timing at which the user can make a reservation at the vacation spot for a long vacation or time for a family trip that the user goes on every year, it is predicted that an appealing effect of the recommendation information to the user is significantly increased.

Further, situations of the vacation spot and the user, changes in the situations, and the like are also important elements in determining contents of the recommendation information and a presentation timing thereof.

A technological idea according to the present disclosure has been conceived in view of the above points, and can present more beneficial recommendation information at a timing suitable for a state of a user. Therefore, as an aspect, an information processing apparatus that achieves an information processing method according to an embodiment of the present disclosure controls presentation of recommendation information to a user on the basis of a recommendation score regarding content. Further, as another aspect, the information processing apparatus according to the embodiment of the present disclosure controls presentation of the recommendation information further on the basis of an acceptability score calculated from matching between a content situation and a user situation.

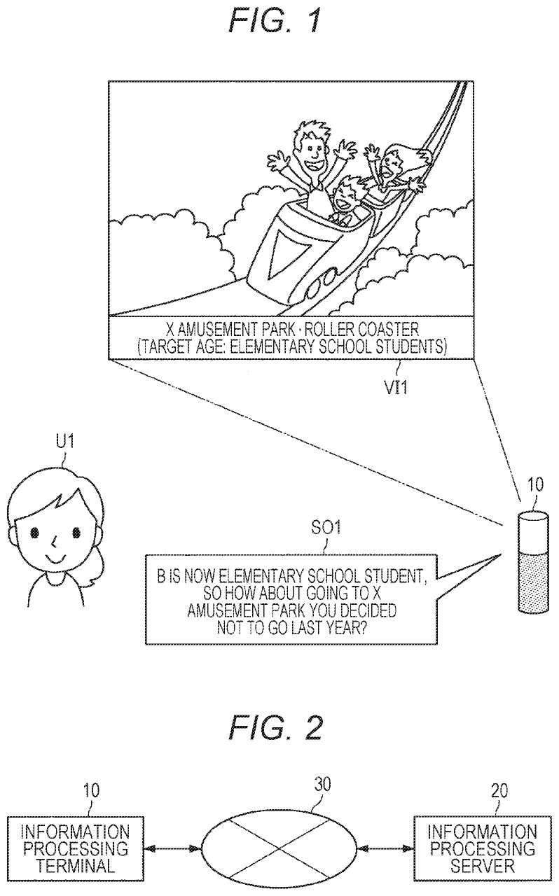

FIG. 1 is an explanatory diagram of the overview of the embodiment of the present disclosure. FIG. 1 illustrates an example where an information processing terminal 10 according to the present embodiment presents recommendation information regarding a vacation spot to a user U1 under the control of an information processing server 20.

As described above, the information processing method according to the present embodiment can control presentation of the recommendation information on the basis of not only the recommendation score that is an index indicating a degree of recommendation regarding the content such as a vacation spot but also the acceptability score calculated from matching between the content situation and the user situation.

For example, in the example in FIG. 1, the information processing server 20 causes the information processing terminal 10 to present recommendation information regarding an X amusement park by using visual information VI1 and a speech utterance SO1 on the basis of an acceptability score calculated from matching with a target age that is a kind of the content situation and the user situation.

More specifically, the information processing server 20 causes the information processing terminal 10 to execute presentation of recommendation regarding the X amusement park on the basis of a result that a child of the user U1 reaches a target age (content situation) defined by the X amusement park because the child has entered an elementary school (user situation).

Further, the information processing server 20 may perform the above presentation control on the basis of the fact that the user U1 has previously given up visiting the X amusement park because the child has not reached the target age. At this time, the information processing server 20 according to the present embodiment can cause the information processing terminal 10 to execute presentation of recommendation information emphasizing that the child has reached the target age by using, for example, the speech utterance SO1 or the like.

As described above, the information processing server 20 according to the present embodiment can provide more beneficial recommendation information to the user at a more suitable timing by considering a daily changing situation of the user.

Hereinabove, the overview of the present embodiment has been described. Hereinafter, characteristics of the information processing apparatus, the information processing method, and a program according to the present embodiment and effects obtained by the characteristics will be described in detail.

### 1.2. System Configuration Example

Next, a system configuration example of the information processing system according to the present embodiment will be described. FIG. 2 is a block diagram illustrating a system configuration example of the information processing system according to the present embodiment. When referring to FIG. 2, the information processing system according to the present embodiment includes the information processing terminal 10 and the information processing server 20. Further, the information processing terminal 10 and the information processing server 20 according to the present embodiment are connected via a network 30 so as to communicate with each other.

### Information Processing Terminal 10

The information processing terminal 10 according to the present embodiment is an information processing apparatus that presents recommendation information to the user under the control of the information processing server 20. The information processing terminal 10 according to the present embodiment transmits collected sound information, image information, and sensor information to the information processing terminal 10, and receives a control signal regarding presentation of recommendation information from the information processing terminal 10.

The information processing terminal 10 according to the present embodiment may be, for example, a mobile phone, a smartphone, a tablet, various home electric appliances, or a dedicated stationary or autonomous mobile apparatus.

### Information Processing Server 20

The information processing server 20 according to the present embodiment is an information processing apparatus that controls presentation of recommendation information to the user by the information processing terminal 10. As described above, as an aspect, the information processing server 20 according to the present embodiment controls presentation of the recommendation information on the basis of not only the recommendation score regarding the content but also the acceptability score calculated from matching between the content situation and the user situation.

### Network 30

The network 30 has a function of connecting the information processing terminal 10 and the information processing server 20. The network 30 may include public networks such as the Internet, a telephone network, and a satellite communication network, various local area networks (LANs) including Ethernet (registered trademark), and various wide area networks (WANs), and the like. Further, the network 30 may also include dedicated networks such as an Internet protocol-virtual private network (IP-VPN). Furthermore, the network 30 may also include wireless communication networks such as Wi-Fi (registered trademark) and Bluetooth (registered trademark).

Hereinabove, the configuration example of the information processing system according to the present embodiment has been described. Note that the above configuration described with reference to FIG. 2 is merely an example, and the configuration of the information processing system according to the present embodiment is not limited to such an example. For example, the functions of the information processing terminal 10 and the information processing server 20 according to the present embodiment may also be achieved by a single apparatus. The configuration of the information processing system according to the present embodiment can be flexibly modified in accordance with specifications or use.

### 1.3. Functional Configuration Example of Information Processing Terminal 10

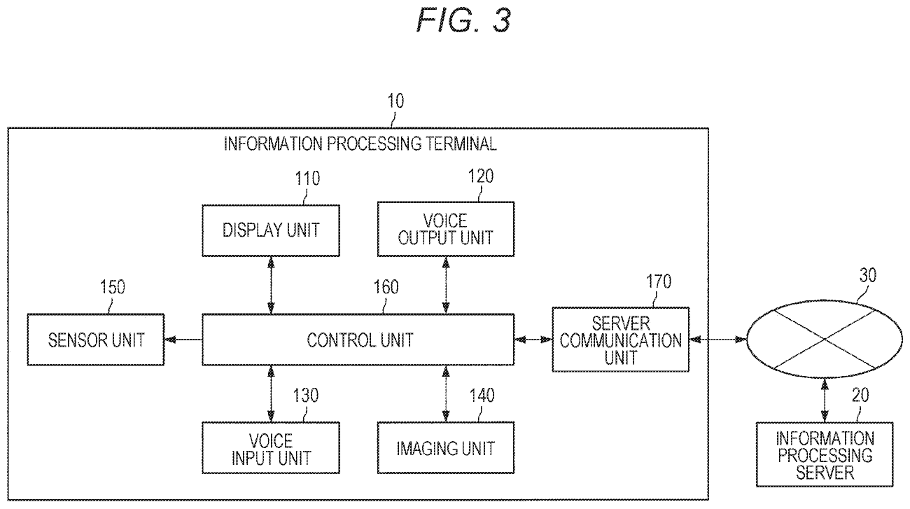

Next, a functional configuration example of the information processing terminal 10 according to the present embodiment will be described. FIG. 3 is a block diagram illustrating a functional configuration example of the information processing terminal 10 according to the present embodiment. When referring to FIG. 3, the information processing terminal 10 according to the present embodiment includes a display unit 110, a voice output unit 120, a voice input unit 130, an imaging unit 140, a sensor unit 150, a control unit 160, and a server communication unit 170.

### Display Unit 110

The display unit 110 according to the present embodiment has a function of outputting visual information such as an image and text. The display unit 110 according to the present embodiment displays, for example, a text and image corresponding to recommendation information under the control of the information processing server 20. It can be said that the display unit 110 is one of a presentation unit according to the present embodiment.

Therefore, the display unit 110 according to the present embodiment includes a display device that presents visual information, and the like. Examples of the above display device include a liquid crystal display (LCD) apparatus, an organic light emitting diode (OLED) apparatus, a touchscreen, and the like. Further, the display unit 110 according to the present embodiment may output the visual information by using a projection function.

### Voice Output Unit 120

The voice output unit 120 according to the present embodiment has a function of outputting various sounds including speech utterances. The voice output unit 120 according to the present embodiment outputs, for example, a speech utterance corresponding to the recommendation information under the control of the information processing server 20. Therefore, the voice output unit 120 according to the present embodiment includes voice output devices such as a speaker and an amplifier. It can be said that the voice output unit 120 is one of the presentation unit according to the present embodiment.

### Voice Input Unit 130

The voice input unit 130 according to the present embodiment has a function of collecting sound information such as an utterance by the user and an ambient sound generated around the information processing terminal 10. The sound information collected by the voice input unit 130 is used by the information processing server 20 for voice recognition, situation analysis, or the like. The voice input unit 130 according to the present embodiment includes a microphone for collecting the sound information.

### Imaging Unit 140

The imaging unit 140 according to the present embodiment has a function of capturing images of the user and a surrounding environment. Image information captured by the imaging unit 140 is used by the information processing server 20 for situation analysis of the user or the like. The imaging unit 140 according to the present embodiment includes an imaging device capable of capturing an image. Note that the above image includes not only a still image but also a moving image.

### Sensor Unit 150

The sensor unit 150 according to the present embodiment has a function of collecting various kinds of sensor information regarding a surrounding environment and behavior and a state of the user. The sensor information collected by the sensor unit 150 is used by the information processing server 20 for situation analysis of the user or the like. The sensor unit 150 includes, for example, an optical sensor including an infrared sensor, an acceleration sensor, a gyro sensor, a geomagnetic sensor, a heat sensor, a vibration sensor, a global navigation satellite system (GNSS) signal receiving device, and the like.

### Control Unit 160

The control unit 160 according to the present embodiment has a function of controlling each configuration included in the information processing terminal 10. The control unit 160 controls, for example, start and stop of each configuration. Further, the control unit 160 inputs a control signal generated by the information processing server 20 to the display unit 110 or the voice output unit 120. Further, the control unit 160 according to the present embodiment may have a function equivalent to that of a presentation control unit 230 of the information processing server 20 described later.

### Server Communication Unit 170

The server communication unit 170 according to the present embodiment has a function of communicating information with the information processing server 20 via the network 30. Specifically, the server communication unit 170 transmits the sound information collected by the voice input unit 130, the image information captured by the imaging unit 140, and the sensor information collected by the sensor unit 150 to the information processing server 20. Further, the server communication unit 170 receives a control signal regarding presentation of the recommendation information and the like from the information processing server 20.

Hereinabove, the functional configuration example of the information processing terminal 10 according to the present embodiment has been described. Note that the above configuration described with reference to FIG. 3 is merely an example, and the functional configuration of the information processing terminal 10 according to the present embodiment is not limited to such an example. For example, the information processing terminal 10 according to the present embodiment does not necessarily need to include all the configurations illustrated in FIG. 3. For example, the information processing terminal 10 can also be configured not to include the sensor unit 150 and the like. Further, as described above, the control unit 160 according to the present embodiment may have a function equivalent to that of the presentation control unit 230 of the information processing server 20. The functional configuration of the information processing terminal 10 according to the present embodiment can be flexibly modified in accordance with specifications or use.

### 1.4. Functional Configuration Example of Information Processing Server 20

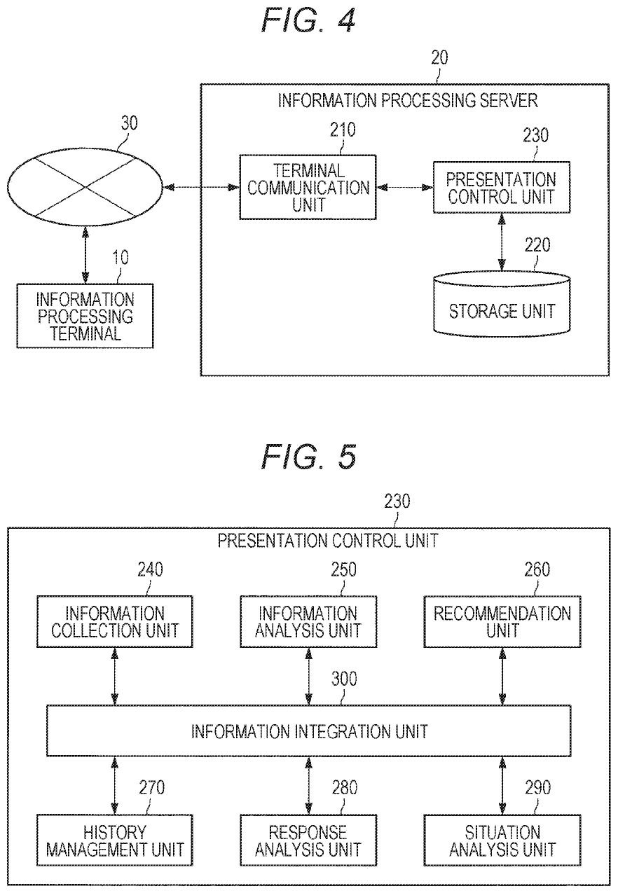

Next, a functional configuration example of the information processing server 20 according to the present embodiment will be described in detail. FIG. 4 is a block diagram illustrating a functional configuration example of the information processing server 20 according to the present embodiment. When referring to FIG. 4, the information processing server 20 according to the present embodiment includes a terminal communication unit 210, a storage unit 220, and the presentation control unit 230.

### Terminal Communication Unit 210

The terminal communication unit 210 according to the present embodiment has a function of communicating information with the information processing terminal 10 via the network 30. Specifically, the terminal communication unit 210 receives the sound information, the image information, the sensor information, and the like from the information processing terminal 10. Further, the terminal communication unit 210 transmits a control signal regarding presentation of the recommendation information to the information processing terminal 10 under the control of the presentation control unit 230.

### Storage Unit 220

The storage unit 220 according to the present embodiment is achieved by a read only memory (ROM) that stores programs, operation parameters, and the like for use in processing of the presentation control unit 230 and a random access memory (RAM) that temporarily stores parameters and the like that change as appropriate.

### Presentation Control Unit 230

The presentation control unit 230 according to the present embodiment has a function of controlling presentation of the recommendation information to the user on the basis of the recommendation score regarding the content. Further, as an aspect, the presentation control unit 230 according to the present embodiment controls presentation of the recommendation information by the information processing terminal 10 further on the basis of the acceptability score calculated from matching between the content situation regarding the content and the user situation regarding the user.

According to the above aspect of the presentation control unit 230 according to the present embodiment, it is possible to provide more beneficial recommendation information to the user at a more appropriate timing based on the user situation at the time of recommendation, a change in the user situation caused by a lapse of time, or the like.

Note that the content according to the present embodiment widely includes products, services, events, vacation spots, behaviors, and the like. Hereinafter, there will be described an example where the content according to the present embodiment is a vacation spot and the presentation control unit 230 controls presentation of recommendation information regarding the vacation spot (hereinafter, also simply referred to as “spot”). However, the presentation control unit 230 according to the present embodiment can control presentation of recommendation information regarding various kinds of content.

Next, a functional configuration example of the presentation control unit 230 according to the present embodiment will be described in detail. FIG. 5 is a block diagram illustrating the functional configuration example of the presentation control unit 230 according to the present embodiment. When referring to FIG. 5, the presentation control unit 230 according to the present embodiment includes an information collection unit 240, an information analysis unit 250, a recommendation unit 260, a history management unit 270, a response analysis unit 280, a situation analysis unit 290, and an information integration unit 300.

### Information Collection Unit 240

The information collection unit 240 according to the present embodiment has a function of collecting metadata regarding the vacation spot or the like from a website, an outing information site, and the like on a network (performing so-called web crawling) and accumulating the collected metadata in a spot information storage unit included in the storage unit 220. Note that the above metadata includes a target age, an address, business hours, a price, access, parking lot information, a genre, detailed metadata (tag information that is arbitrarily attached by a user of the information site, and the like), a weather forecast in a surrounding area, comments (experiences), and the like of the vacation spot.

### Information Analysis Unit 250

The information analysis unit 250 according to the present embodiment analyzes the metadata collected by the information collection unit 240. Specifically, the information analysis unit 250 generates, for each spot (content), a vector (content profile) having a score for each attribute value of the metadata by using a method disclosed in Japanese Patent Application Laid-Open No. 2005-176404 or other methods.

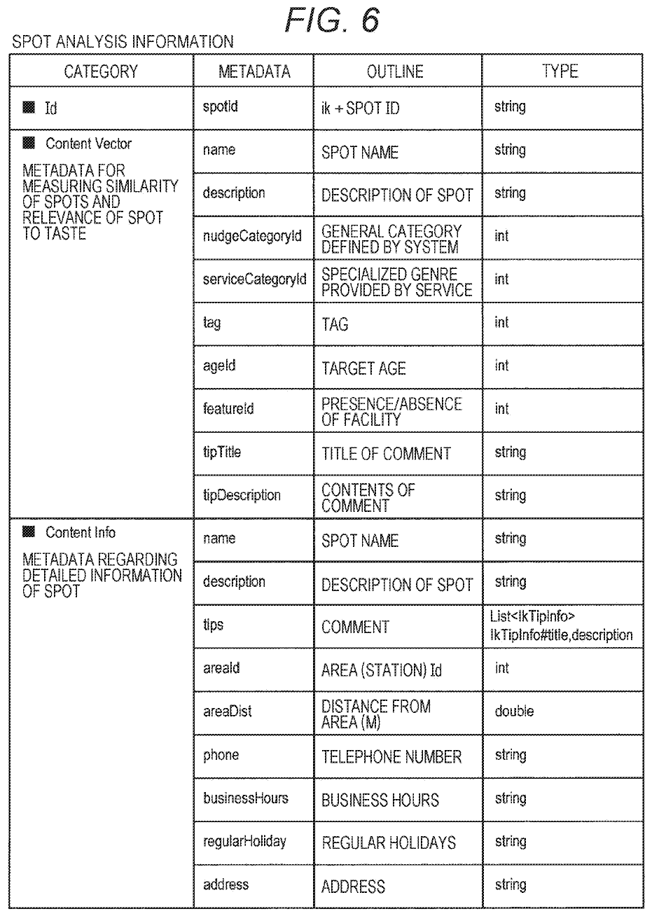

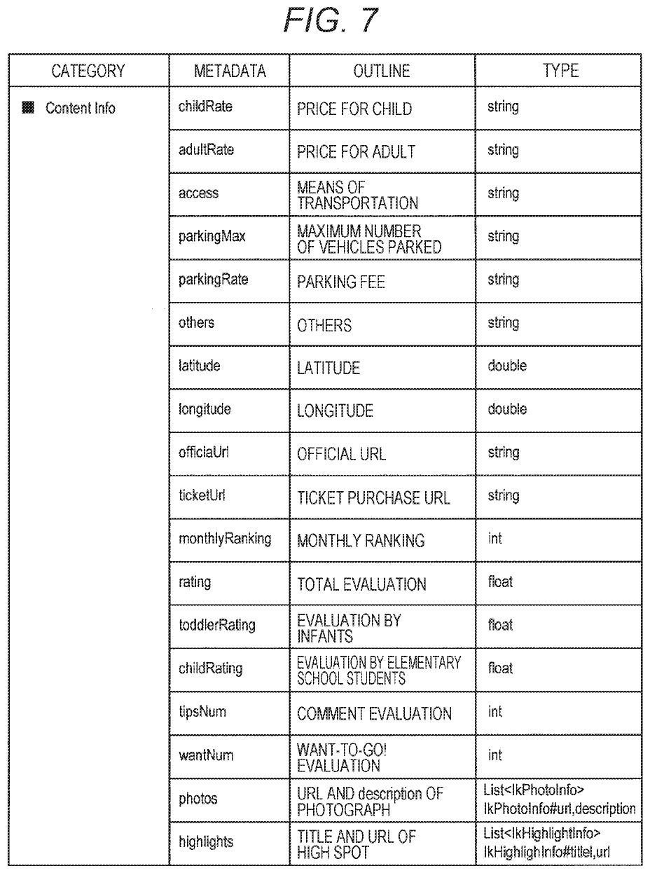

Herein, FIGS. 6 and 7 illustrate an example of a data structure of the spot analysis information. As illustrated in FIGS. 6 and 7, the data structure of the spot analysis information includes “ID”, “Content Vector”, and “Content Info”.

The “Content Vector” is metadata used for measuring similarity of spots and relevance of a spot to the user's taste. The “Content Vector” includes, for example, description of the spot (introduction sentence cluster), a general category, a specialized genre provided by a service, a tag, a target age, presence/absence of a facility, a title of a comment, and contents of the comment (comment cluster).

Further, the “Content Info” is metadata regarding detailed information of the spot. The “Content Info” includes, for example, an area, a telephone number, business hours, an address, a price, a latitude and longitude, evaluation, and the like.

Note that a distinction between the “Content Vector” and the “Content Info” is merely an example. The “Content Vector” and the “Content Info” may partially overlap or may be appropriately defined for their use. Further, a string text is morphologically analyzed (a target part of speech can be specified), and is expressed as a vector of a keyword “(keyword, frequency)”. For example, the string text is converted into (aquarium, 2), (attraction, 3), (restaurant, 2), (shopping, 1), (hotel, 1), or (amusement, 1).

Further, probabilistic latent semantic analysis (PLSA) and latent Dirichlet allocation (LDA), which are widely used for text classification as a method of a latent topic model, may be used in clustering an introduction sentence and a comment. Regarding details of PLSA, Non-Patent Document 1: Thomas Hofmann, “Probabilistic latent semantic indexing”, 1999, Proceedings of the 22^{nd} annual international ACM SIGIR conference ON Research and development in information retrieval is referred to. Further, regarding details of LDA, Non-Patent Document 2: David M. Blei, Andrew Y. Ng, Michael I. Jordan, “Latent Dirichlet Allocation”, 2003, Journal of Machine Learning Research, Volume 3 is referred to.

In PLSA, for example, an occurrence probability p(w|d) of a word w in an introduction sentence d is expressed by using a latent topic z as in the following expression.

$$p ( w \vert d ) = {\sum }_{z} p ( w \vert z ) p ( z \vert d ) \qquad [ Expression 1 ]$$

In other words, it is possible to resolve the occurrence probability of the word in the introduction sentence into “occurrence probability of the word for each latent topic” and “topic attribution probability of the introduction sentence” by considering the latent topic z to be a latent topic in which the introduction sentence and the word occur. In a case where a dimensional number of the topic z is 5, an attribution probability of a topic regarding introduction of a certain spot is expressed as {0.4, 0.1, 0.7, 0.2, 0.5}, and this is a result of clustering.

Further, in the above metadata, the “nudge Category Id” is a general category defined by the system, and the “service Category Id” is a specialized genre provided by a service. The “nudge Category” includes, for example, CAMP, BBQ, GUEST RANCH, OUTDOOR LEISURE, PARK, DOG RUN, AMUSEMENT PARK, THEME PARK, AQUARIUM, ZOO, FOOD THEME PARK, SCIENCE MUSEUM, MUSEUM, ART MUSEUM, SHRINE, TEMPLE, and the like. Further, the “service Category” includes INDOOR AMUSEMENT PARK, SAFARI PARK, BOTANICAL GARDEN, FISHING, HIKING, FRUIT PICKING, FARMING ACTIVITY, SOCIAL STUDY, EXPERIENCE FACILITY, and the like.

### Recommendation Unit 260

The recommendation unit 260 according to the present embodiment generates recommendation information regarding content on the basis of the user's taste or habit.

First, the recommendation unit 260 generates recommendation information according to the user's taste on the basis of information regarding the user's taste and the spot analysis information (vectored content profile) analyzed by the information analysis unit 250. Specifically, the recommendation unit 260 matches a user preference obtained by analyzing a behavior history of the user included in a user history managed by the history management unit 270 with the above content profile, thereby generating recommendation information in each condition. The user preference may be expressed as a vector generated from metadata of behaviors of the user in the user history or a weighted sum of the content profile.

The recommendation unit 260 can also generate the user preference by vectoring the attribute value on the basis of the user history. In this case, the recommendation unit 260 matches the user preference with the content profile (calculates an inner product for each item) and generates recommendation information on the basis of a calculated recommendation score (a sum total of the inner products of the vectors, or the like) by using, for example, the method disclosed in Japanese Patent Application Laid-Open No. 2005-176404.

For example, the recommendation unit 260 generates recommendation information of the vacation spot based on the user's taste in accordance with a season (spring, summer, autumn, or winter), a period (one day, one night, or two or more nights), and a purpose (family trip, eating out as a married couple, going out as a parent and child, or shopping as a parent and child). Specifically, for example, recommendation results based on recommendation conditions are generated as described below. At this time, the recommendation unit 260 may set a predetermined filter such as excluding a spot that the user has already visited from the recommendation results.

### Examples of Spot Recommendation Result

Recommendation conditions a: spring, one night, family trip
1st ABC ryokan (Japanese-style hotel)
2nd ABC theme park
3rd ABC ranch

Recommendation b: summer, two or more nights, family trip
1st ABC hotel
2nd ABC ryokan (Japanese-style hotel)
3rd ABC amusement park

Recommendation c: winter, one-day trip, going out as a parent and child
1st ABC concert
2nd ABC aquarium
3rd ABC museum

Note that the recommendation unit 260 can also similarly generate recommendation information for a user group (a family, a group of friends, or the like) on the basis of a plurality of user preferences.

Further, the recommendation unit 260 has a function of predicting an event that may occur in the future on the basis of the user history. Specifically, the recommendation unit 260 extracts past events from the user history and predicts a timing at which the next event will occur. For example, in a case where the user travels abroad during consecutive holidays in a specified time every year, the recommendation unit 260 predicts that a foreign travel event will also occur during the next consecutive holidays in the same time. As described above, the recommendation unit 260 can grasp a habit of the user on the basis of the user history and predict occurrence of an event.

Then, the recommendation unit 260 acquires a recommendation result by using the predicted event as a recommendation condition. Note that the recommendation unit 260 may acquire a plurality of recommendation results (top five vacation spots or the like) by using the predicted event as the recommendation condition.

Next, the recommendation unit 260 determines a notification timing to notify the user of the recommendation information. As described above, because a timing at which the user determines his/her behavior is different depending on the user, the recommendation unit 260 determines an appropriate notification timing on the basis of the user history. Specifically, for example, the recommendation unit 260 may estimate a difference between time information of a past event for the same purpose (a date at which the event has been actually executed) and a date at which the event has been registered in schedule information (or an average value of the differences from a plurality of past events) as a preparation period of the event, and determine a date and time obtained by subtracting the preparation period from a date and time of occurrence of the predicted event as an optimal timing for encouraging the user to register a schedule of the predicted event.

Herein, as an example, a time at which preparation or planning of the event is started is set as the date and time to register the event in the schedule information. However, the present embodiment is not limited to such an example, and, for example, the date and time may be a date and time at which the user performs a search regarding the event for the same purpose (a search on a web search site, a search using a voice agent, or the like), or may be a date and time at which the user has a conversation regarding the event for the same purpose (a conversation with another user via email or chat, a conversation with a voice agent, or the like).

Further, the recommendation unit 260 may calculate the above preparation period in accordance with a genre in the recommended event, such as a vacation spot. For example, the preparation period is calculated to be thirty days before the event if the event is a hotel, three days before the event if the event is a theme park, seven days before the event if the event is a ranch, or the like. Further, the recommendation unit 260 may change the above preparation period further on the basis of a season, time, or popularity. Thus, for example, it is necessary to make an accommodation reservation in a case of hotels, and the hotels are crowded depending on a season or time. Therefore, the recommendation unit 260 can make a recommendation to the user early, considering a risk that rooms may be fully reserved.

Further, as an aspect, the recommendation unit 260 according to the present embodiment generates recommendation information on the basis of not only the recommendation score described above but also the acceptability score calculated from matching between the content situation and the user situation.

More specifically, the recommendation unit 260 according to the present embodiment may calculate acceptability for each situation attribute included in the content situation and the user situation, and calculate a final acceptability score on the basis of the acceptability for each situation attribute.

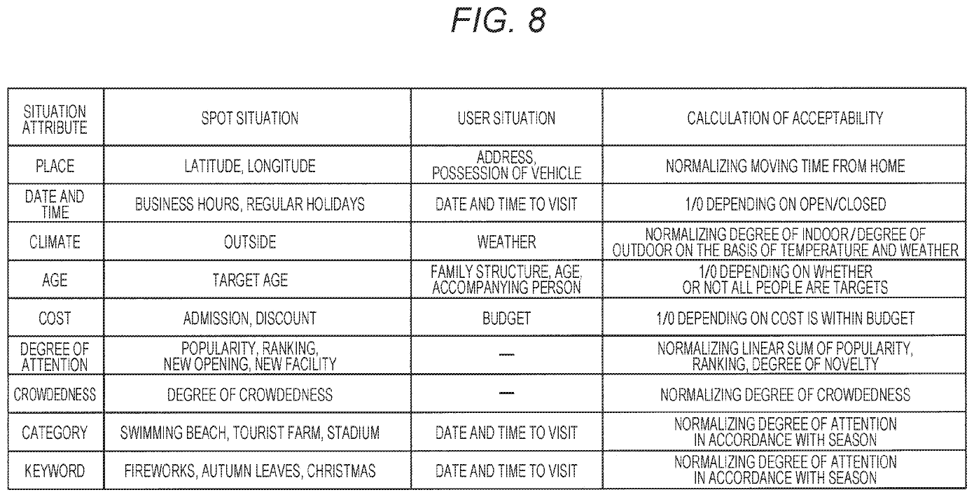

FIG. 8 is an explanatory diagram of calculation of the acceptability for each situation attribute according to the present embodiment. As illustrated in FIG. 8, the situation attributes according to the present embodiment may include attributes such as, for example, a place, a date and time, a climate, an age, a cost, a degree of attention, crowdedness, a category, and a keyword. The situation attributes according to the present embodiment are attributes indicating situations of the vacation spot and the user.

For example, in a case where the situation attribute is “place”, a spot situation (content situation) includes position information regarding the vacation spot, and the user situation includes the user's home address, possession or non-possession of a vehicle, and the like. At this time, the recommendation unit 260 may calculate acceptability regarding the situation attribute of “place” by normalizing a moving time while considering means of transportation from the user's home to the vacation spot.

Further, for example, in a case where the situation attribute is “date and time”, the spot situation includes business hours and regular holidays of the vacation spot, and the user situation includes a date and time at which the user plans to visit the vacation spot. At this time, the recommendation unit 260 may determine whether or not the vacation spot is in business at the date and time to visit, and set 1 or 0 as acceptability regarding the situation attribute of “date and time”.

Further, for example, in a case where the situation attribute is “climate”, the spot situation includes a situation regarding an influence of a climate, such as a situation in which the vacation spot is an indoor facility, and the user situation includes weather in an area around the vacation spot at the date and time to be visited by the user. As described above, the user situation according to the present embodiment may widely include various situations in which the user may be placed. At this time, the recommendation unit 260 may calculate acceptability regarding the situation attribute of “climate” by normalizing tolerability of behaviors inside or outside a facility on the basis of a temperature and weather.

Further, for example, in a case where the situation attribute is “age”, the spot situation includes a target age of the vacation spot, and the user situation includes an age of a target user who visits the vacation spot (including a family member and an accompanying person). At this time, the recommendation unit 260 may determine whether or not all target users reach the target age, and set 1 or 0 as acceptability regarding the situation attribute of “age”. Further, the recommendation unit 260 may calculate the acceptability on the basis of a percentage of users who reach the target age in the target users.

Further, for example, in a case where the situation attribute is “cost”, the spot situation includes a price for the vacation spot (including admission, an accommodation charge, a discount, and the like), and the user situation includes a budget of the user. At this time, the recommendation unit 260 may determine whether or not the a price for the vacation spot are within the budget of the user, and set 1 or 0 as acceptability regarding the situation attribute of “cost”.

Further, for example, in a case where the situation attribute is “degree of attention”, the spot situation includes situations regarding novelty of the vacation spot, such as popularity, a ranking, new opening, and a new facility. At this time, the recommendation unit 260 may calculate acceptability regarding the situation attribute of “degree of attention” by normalizing a linear sum regarding popularity, a ranking, and a degree of novelty.

Further, for example, in a case where the situation attribute is “crowdedness”, the spot situation includes a degree of crowdedness of the vacation spot at the date and time to visit. At this time, the recommendation unit 260 may calculate acceptability regarding the situation attribute of “crowdedness” by normalizing the above degree of crowdedness.

Further, for example, in a case where the situation attribute is “category”, the spot situation includes a situation indicating whether or not the vacation spot is in a category whose degree of attention changes depending on a season, such as a swimming beach, a tourist farm, or a stadium, and the user situation includes the date and time to visit. At this time, the recommendation unit 260 may calculate acceptability regarding the situation attribute of “category” by normalizing the degree of attention in accordance with the season.

Further, for example, in a case where the situation attribute is “keyword”, the spot situation includes a situation indicating whether or not the vacation spot is related to a keyword whose degree of attention changes depending on a season, such as cherry blossoms, fireworks, autumn leaves, or Christmas, and the user situation includes the date and time to visit. At this time, the recommendation unit 260 may calculate acceptability regarding the situation attribute of “keyword” by normalizing the degree of attention in accordance with the season.

Hereinabove, the situation attributes according to the present embodiment have been described by using specific examples. As described above, the recommendation unit 260 according to the present embodiment can acquire a recommendation result regarding the vacation spot on the basis of the acceptability based on a matching result for each situation attribute. According to the above function of the recommendation unit 260, it is possible to present more flexible and effective recommendation information to the user in accordance with not only a simple recommendation score regarding the vacation spot but also the user situation that daily changes.

Meanwhile, it is also expected that an important situation attribute may differ depending on the user's taste or the like. Therefore, the recommendation unit 260 according to the present embodiment can calculate a more accurate acceptability score by dynamically setting, on the basis of a situation attribute (also referred to as “situational reason”) that the user regards as important, a weight applied to the situation attribute.

Herein, the above weight is a value indicating a degree of importance of the situation attribute for the user, and is used for calculating the acceptability score. Further, the above situational reason corresponds to a reason that influences an increase/decrease in the weight, i.e., the user's taste.

The recommendation unit 260 according to the present embodiment can acquire the above situational reason on the basis of, for example, an answer of the user to an inquiry, an utterance of the user, a tendency of the user individual, or the like.

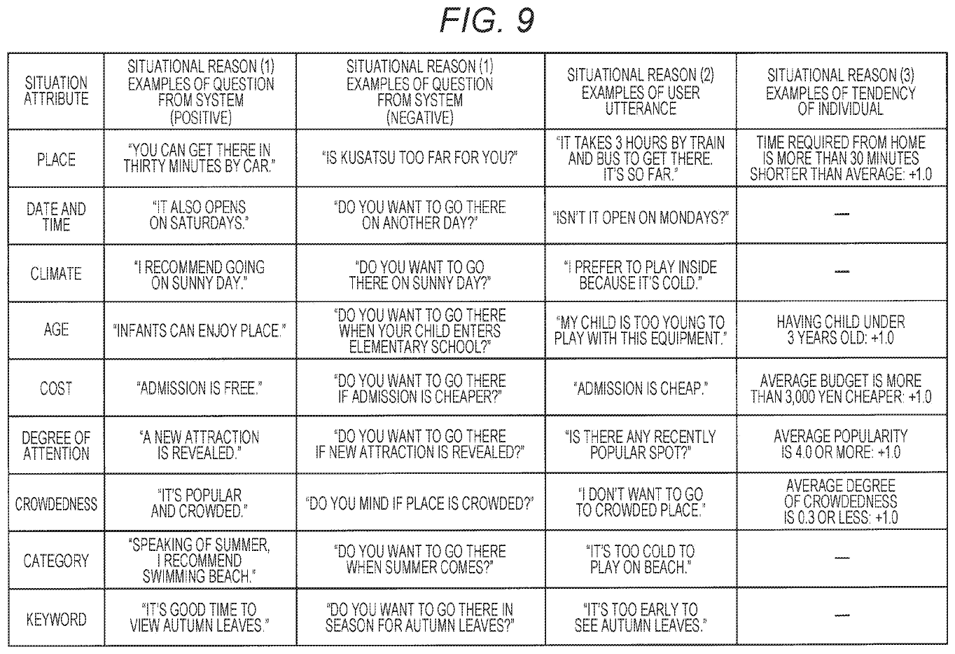

FIG. 9 is an explanatory diagram of situational reasons according to the present embodiment.

The recommendation unit 260 can acquire a situational reason on the basis of, for example, a response of the user to a positive or negative inquiry to the user. Specifically, for example, in a case where a situational reason regarding the situation attribute of “place” is acquired, the recommendation unit 260 may acquire the situational reason on the basis of a result of a response of the user to an inquiry such as “You can get there in thirty minutes by car.” (positive) or “Is Kusatsu too far for you?” (negative). For example, in a case where the user says “That's nice.” in response to the above positive inquiry, or in a case where the user says “Yes, it is.” in response to the above negative inquiry, the user may add +1.0 to a weight regarding the situation attribute of “place”.

Further, for example, the recommendation unit 260 can grasp that the user regards the situation attribute of “place” as important on the basis of a negative utterance “It takes three hours by train and bus to get there. It's so far.” given by the user who sees the recommendation information. In this case, the recommendation unit 260 may add +1.0 to the weight regarding the situation attribute of “place”. Meanwhile, in a case where the user gives a positive utterance such as “It's near. That's nice.”, the recommendation unit 260 may add +1.0 to the weight regarding the situation attribute of “place”.

Further, for example, the recommendation unit 260 may acquire a situational reason on the basis of the tendency of the user individual based on a difference from a general model. The recommendation unit 260 can regard a situation attribute deviating from an average of all users (general model) as the tendency of the user individual, and add or subtract a weight on the basis of a rule defined for each situation attribute. For example, in a case where time required from the user's home to the vacation spot is more than thirty minutes shorter than the average of the general model, the recommendation unit 260 may add +1.0 to the weight regarding the situation attribute of “place”.

As described above, the recommendation unit 260 according to the present embodiment can calculate a more accurate acceptability score in accordance with the situation or taste of the user by dynamically setting the weight on the basis of a daily changing attribute that is important for the user.

### History Management Unit 270

The history management unit 270 according to the present embodiment performs data management such as registration and update of the user history in the user history storage unit included in the storage unit 220. The user history includes, as the behavior history, schedule history information, event occurrence history information (which may reflect a recognition result of a user behavior associated with a mobile device), an operation history (search history, viewing history, and the like), a user response history, and the like. Note that the above event occurrence history information may reflect, for example, a recognition result of a user behavior associated with a mobile device or the like. For example, it is possible to determine whether or not the user has actually visited the vacation spot registered as a schedule on the basis of position information acquired from the mobile device, a sentence or an image input by the user in an SNS or message application, or the like.

Further, the user response history is a user response (operation history such as viewing detailed information, bookmarking, reservation, registration of a schedule, or deletion, or a user utterance) to the recommendation information analyzed by the response analysis unit 280 or a user response (evaluation or the like) to experience of the event, and may accumulate user responses together with the user situation and the content situation analyzed by the situation analysis unit 290.

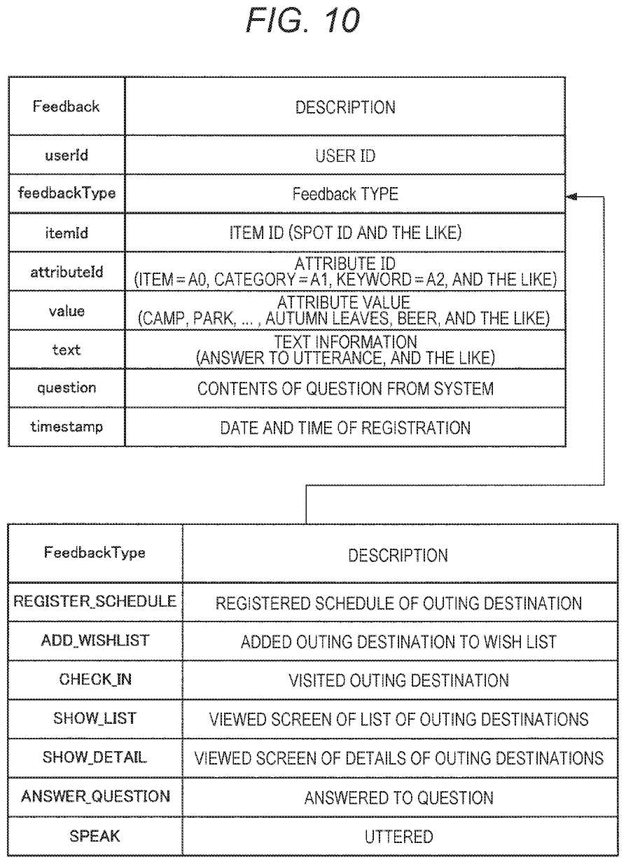

Herein, FIG. 10 illustrates an example of a data structure of the user history (feedback) according to the present embodiment. As illustrated in FIG. 10, the user history includes a user ID, a feedback type, an item ID (vacation spot ID, or the like), an attribute ID, an attribute value corresponding to the attribute ID, and the like.

Further, the user history according to the present embodiment may include the inquiries described above, answers of the user to the inquiries, and text information corresponding to a spontaneous utterance of the user.

Note that, as illustrated in FIG. 10, the feedback type includes registration of a schedule of an outing destination (vacation spot) (schedule history information), addition of the outing destination to a wish list, an actual visit to the outing destination (event occurrence history information), and viewing a screen of a list of outing destinations and a screen of details (user response history).

Further, the feedback type according to the present embodiment may also include the user answering to an inquiry, detecting an utterance of the user regarding the situational reason, and the like.

### Response Analysis Unit 280

The response analysis unit 280 analyzes, for example, a user response (operation input/selection, text input, utterance, expression, biological response, or the like) at the time of delivering information (specifically, for example, at the time of recommending an event) or at the time of recognizing a behavior (specifically, for example, at the time of experiencing the event). The user response at the time of experiencing the event may be acquired by, for example, causing the voice agent or the like to ask a question to encourage the user to make an evaluation.

### Situation Analysis Unit 290

The situation analysis unit 290 according to the present embodiment has a function of analyzing the content situation and the user situation. As described above, the situation attributes analyzed by the situation analysis unit 290 may include a place, a date and time, a climate, an age, a cost, a degree of attention, crowdedness, a category, a keyword, and the like. Meanwhile, the above situation attributes are merely examples, and the situation attributes according to the present embodiment are not limited to such examples. The situation analysis unit 290 according to the present embodiment may analyze a situation attribute other than the above situation attributes, and may not analyze all the above attributes.

### Information Integration Unit 300

The information integration unit 300 delivers information obtained from each configuration and controls communication of information with the information processing terminal 10. The information integration unit 300 outputs, for example, spot information collected by the information collection unit 240 to the information analysis unit 250 and outputs the spot analysis information (content profile) analyzed by the information analysis unit 250 to the recommendation unit 260. Further, the information integration unit 300 outputs the user history managed by the history management unit 270 to the recommendation unit 260. Further, the information integration unit 300 outputs the user response obtained by the response analysis unit 280 and the spot situation and user situation obtained by the situation analysis unit 290 to the recommendation unit 260.

### 1.5. Flow of Operation

Next, a flow of operation of the information processing server 20 according to the present embodiment will be described in detail.

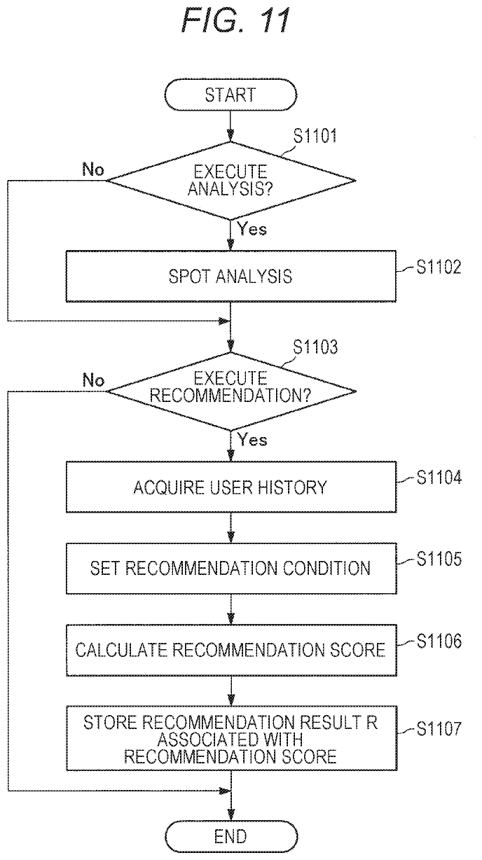

First, a flow of calculating a recommendation score according to the present embodiment will be described in detail. FIG. 11 is a flowchart showing a flow of calculating a recommendation score according to the present embodiment.

When referring to FIG. 11, first, the information analysis unit 250 determines whether or not to execute spot analysis regarding a vacation spot or the like (S1101).

Herein, in a case where the analysis is executed (S1101: Yes), the information analysis unit 250 generates a content profile on the basis of metadata and text information of the spot collected by the information collection unit 240 (S1102).

Next, the recommendation unit 260 determines whether or not to execute presentation of recommendation information (S1103). Herein, in a case where the recommendation information is not presented (S1103: No), the presentation control unit 230 terminates the processing.

Meanwhile, in a case where the recommendation information is presented (S1103: Yes), the recommendation unit 260 acquires the user history from the history management unit 270 (S1104). At this time, a content profile regarding a target spot of a target feedback type included in the user history is acquired, and a user preference is acquired on the basis of the content profile. Note that a plurality of the target feedback types may be selected, or the target feedback type may be weighted.

Next, the recommendation unit 260 sets a recommendation condition (S1105). The above recommendation condition includes, for example, a date and time, a period, a purpose, and the like as described above.

Next, the recommendation unit 260 calculates a recommendation score on the basis of the recommendation condition set in step S1105 (S1106).

Next, the recommendation unit 260 stores a recommendation result R associated with the recommendation score calculated in step S1106 (S1107).

Next, calculation of the recommendation score according to the present embodiment will be described by using a specific example.

For example, the information analysis unit 250 generates the following content profiles in step S1102.

Spot A:

{hot spring=1.0, Kusatsu=1.0, open-air bath=0.6, buffet=0.4, massage=0.2} [latitude=xxx, longitude=xxx, popularity=4.1, price for adults=15,000 yen, price for children=10,000 yen]

Spot B:

{theme park=1.0, Fuji=1.0, safari=0.8, experience=0.5, bus=0.3} [latitude=xxx, longitude=xxx, popularity=4.4, price for adults=27,000 yen, price for children=1,500 yen]

Spot C:

{campsite=1.0, Tanzawa=1.0, dog park=0.7, cottage=0.5, bread=0.4} [latitude=xxx, longitude=xxx, popularity=3.6, price=4,000 yen]

Further, the recommendation unit 260 acquires the following user history in step S1104. Note that, herein, an operation history of spots registered as schedules is acquired as the feedback type.

2015/05 “family trip”->one night, spot X:

{hot spring=1.0, Atami=1.0, open-air bath=0.6, Italian cuisine=0.4, beauty salon=0.1} [latitude=xxx, longitude=xxx, popularity=3.8, price for adults=12,000 yen, price for children=8,000]

2016/05 “family trip”->one night, spot Y:

{hot spring=1.0, Nasu Highlands=1.0, cottage=0.5, Japanese cuisine=0.3, massage=0.2} [latitude=xxx, longitude=xxx, popularity=4.2, price for adults=16,000 yen, price for children=10,000]

2016/11 “going out as a parent and child”->one night,

spot Z:

{campsite=1.0, Minamiboso=1.0, fishing=0.7, tent=0.3, hiking=0.2} [latitude=xxx, longitude=xxx, popularity=3.7, price=5,000 yen]

Further, the recommendation unit 260 sets the following recommendation conditions in step S1105.

date and time: 2017/05/01=[spring], period: [one night], purpose: [family trip]

Further, the recommendation unit 260 calculates a recommendation score in step S1106 as described below. Note that “UP” in the following description indicates a user preference.

UP [spring]=spot X+spot Y:

{hot spring=2.0, Atami=1.0, Nasu Highlands=1.0, open-air bath=0.6, Italian cuisine=0.4, beauty salon=0.1, cottage=0.5, Japanese cuisine=0.3, massage=0.2}

Vector cosine calculation between UP [spring] and spots A, B, and C:

UP-A: {1.0*2.0 (hot spring)+0.6*0.6 (open-air bath)+0.2*0.2 (massage)}/{√(2.0\hat{ }2+1.0\hat{ }2+1.0\hat{ }2+0.6\hat{ }2+0.4\hat{ }2+0.1\hat{ }2+0.5\hat{ }2+0.3\hat{ }2+0.2\hat{ }2) (UP norm)* √(1.0\hat{ }2+1.02\hat{ }2+0.6\hat{ }2+0.4\hat{ }2+0.2\hat{ }2) (A norm)}=2.4/{√6.91*√2.56}=0.570

UP-B: 0.00 (no common metadata)

UP-C: {0.5*0.5 (cottage)/{√(2.0\hat{ }2+1.0\hat{ }2+1.0\hat{ }2+0.6\hat{ }2+0.4\hat{ }2+0.1\hat{ }2+0.5\hat{ }2+0.3\hat{ }2+0.2\hat{ }2) (UP norm)*√/(1.0\hat{ }2+1.0\hat{ }2 +0.7\hat{ }2+0.5\hat{ }2+0.4\hat{ }2) (C norm)}=0.25/{√6.91*√2.9}=0.055

UP [one night]=spot X+spot Y+spot Z:

{hot spring=2.0, campsite=1.0, Atami=1,0, Nasu Highlands=1.0, Minamiboso=1.0, open-air bath=0.6, Italian cuisine=0.4, beauty salon=0.1, cottage=0.5, Japanese cuisine=0.3, massage=0.2, fishing=0.7, tent=0.3, hiking=0.2}

Vector cosine calculation between UP [one night] and spots A, B, and C:

UP-A: {1.0*2.0 (hot spring)+0.6*0.6 (open-air bath)+0.2*0.2 (massage)}/{√(2.0\hat{ }2+1.0\hat{ }2+1.0\hat{ }2+1.0\hat{ }2+1.0\hat{ }2+0.6\hat{ }2+0.4\hat{ }2+0.1\hat{ }2+0.5\hat{ }2+0.3\hat{ }2+0.2\hat{ }2+0.7\hat{ }2+0.3\hat{ }2+0.2\hat{ }2) (UP norm)*√(1.0\hat{ }2+1.0\hat{ }2+0.6\hat{ }2+0.4\hat{ }2+0.2\hat{ }2) (A norm)}=2.4/{√9.53*√/2.56}=0.485

UP-B: 0.00 (no common metadata)

UP-C: {1.0*1.0 (campsite)+0.5*0.5 (cottage)/{√(2.0\hat{ }2+1.0\hat{ }2+1.0\hat{ }2+1.0\hat{ }2+1.0\hat{ }2+0.6\hat{ }2+0.4\hat{ }2+0.1\hat{ }2+0.5\hat{ }2+0.3\hat{ }2+0.2\hat{ }2+0.7\hat{ }2+0.3\hat{ }2+0.2\hat{ }2) (UP norm)*√(1.0\hat{ }2+1.0\hat{ }2 +0.7\hat{ }2+0.5\hat{ }2+0.4\hat{ }2) (C norm)}=1.25/{√9.53*√2.9}=0.237

UP [family trip]=Spot X+spot Y:

{hot spring=2.0, Atami=1.0, Nasu Highlands=1.0, open-air bath=0.6, Italian cuisine=0.4, beauty salon=0.1, cottage=0.5, Japanese cuisine=0.3, massage=0.2}

Vector cosine calculation between UP [spring] and the spots A, B, and C:

UP-A: {1.0*2.0 (hot spring)+0.6*0.6 (open-air bath)+0.2*0.2 (massage)}/{√(2.0\hat{ }2+1.0\hat{ }2+1.0\hat{ }2+0.6\hat{ }2+0.4\hat{ }2+0.1\hat{ }2+0.5\hat{ }2+0.3\hat{ }2+0.2\hat{ }2) (UP norm)*√(1.0\hat{ }2+1.0\hat{ }2+0.6\hat{ }2 +0.4\hat{ }2+0.2\hat{ }2) (A norm)}=2.4/{√6.91*√2.56}=0.570

UP-B: 0.00 (no common metadata)

UP-C: {0.5*0.5 (cottage)/{√(2.0\hat{ }2+1.0\hat{ }2+1.0\hat{ }2+0.6\hat{ }2+0.4\hat{ }2+0.1\hat{ }2+0.5\hat{ }2+0.3\hat{ }2+0.2\hat{ }2) (UP norm)*√(1.0\hat{ }2+1.0\hat{ }2 +0.7\hat{ }2+0.5\hat{ }2+0.4\hat{ }2) (C norm)}=0.25/{√6.91*√2.9}=0.055

The following recommendation scores are calculated from the above calculations.

UP-A [comprehensive]=UP-A [spring]+UP-A [one night]+UP-A [family trip]=0.570+0.485+0.570=1.625

UP-B [comprehensive]=UP-B [spring]+UP-B [one night]+UP-B [family trip]=0.000+0.000+0.000=0.000

UP-C [comprehensive]=UP-C [spring]+UP-C [one night]+UP-C [family trip]=0.055+0.237+0.055=0.347

Note that the recommendation unit 260 may narrow down target spots on the basis of the calculated recommendation scores. The recommendation unit 260 can perform condition filtering such as, for example, excluding a result of popularity=less than 3.5 from recommendation results.

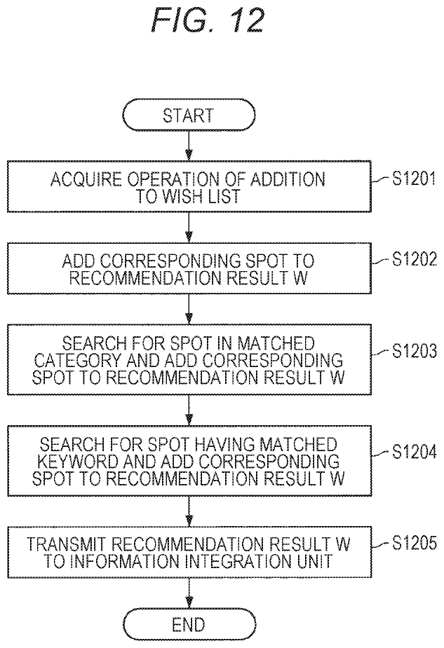

Next, a flow of acquiring a recommendation result based on a wish list according to the present embodiment will be described. FIG. 12 is a flowchart showing a flow of acquiring a recommendation result based on a wish list according to the present embodiment.

When referring to FIG. 12, first, the recommendation unit 260 acquires, from the user history, history information regarding operation of addition to the wish list (S1201).

Next, the recommendation unit 260 adds a spot corresponding to the item ID to a recommendation result W on the basis of the history information acquired in step S1201 (S1202).

Next, the recommendation unit 260 searches for a spot in a matched category on the basis of the history information acquired in step S1201, and adds the spot to the recommendation result W (S1203).

Next, the recommendation unit 260 searches for a spot having a matched keyword on the basis of the history information acquired in step S1201, and adds the spot to the recommendation result W (S1204).

Next, the recommendation unit 260 transmits the recommendation result W generated in steps S1202 to 1204 to the information integration unit 300 (S1205).

Then, a flow of calculating an acceptability score according to the present embodiment will be described in detail. The recommendation unit 260 according to the present embodiment can calculate a final acceptability score by using the acceptability and weight for each attribute situation described above.

At this time, the recommendation unit 260 according to the present embodiment may use, as the final acceptability score, comprehensive acceptability calculated by using the above acceptability and weight or a comprehensive acceptability difference indicating a difference between comprehensive acceptability previously calculated and comprehensive acceptability currently calculated.

For example, in a case where the number of situation attributes whose acceptability has been changed is equal to or more than a threshold, the recommendation unit 260 according to the present embodiment may adopt the comprehensive acceptability difference as the final acceptability score. According to the above function of the recommendation unit 260, it is possible to present, to the user, recommendation information more suitable for the user situation that changes as time elapses.

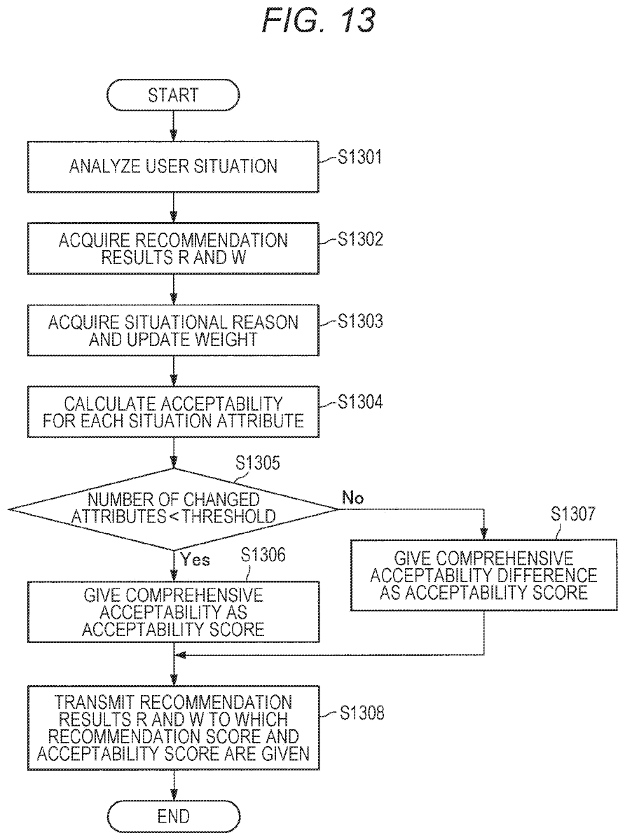

FIG. 13 is a flowchart showing a flow of calculating an acceptability score according to the present embodiment.

When referring to FIG. 13, first, the situation analysis unit 290 analyzes the user situation (S1301).

Next, the recommendation unit 260 acquires the recommendation results R and W described above (S1302).

Then, the recommendation unit 260 acquires a situational reason on the basis of the user history, and updates a weight for each situation attribute used for calculating an acceptability score (S1303). As described above, the recommendation unit 260 can acquire the situational reason from an answer to an inquiry, an utterance of the user, a tendency of the user individual, or the like.

Then, the recommendation unit 260 calculates acceptability for each situation attribute (S1304). At this time, the recommendation unit 260 stores a value of the acceptability currently calculated and a value of a difference from acceptability previously calculated.

Next, the recommendation unit 260 determines whether or not the number of situation attributes whose acceptability has been changed from the previous time is less than the threshold (S1305). Note that, as examples of a change in the acceptability according to the user situation, various factors are expected, such as moving, purchasing a vehicle, having a child, a child reaching a target age, and an increase and decrease in a budget.

Herein, in a case where the number of situation attributes whose acceptability has been changed is less than the threshold (S1305: Yes), the recommendation unit 260 gives the comprehensive acceptability to the recommendation results R and W as the final acceptability score (S1306).

Meanwhile, in a case where the number of situation attributes whose acceptability has been changed is equal to or more than the threshold (S1305: No), the recommendation unit 260 gives the comprehensive acceptability difference to the recommendation results R and W as the final acceptability score (S1307).

Then, the recommendation unit 260 transmits, to the information integration unit 300, the recommendation results R and W associated with the recommendation score and the acceptability score adopted in step S1306 or S1307 (1308).

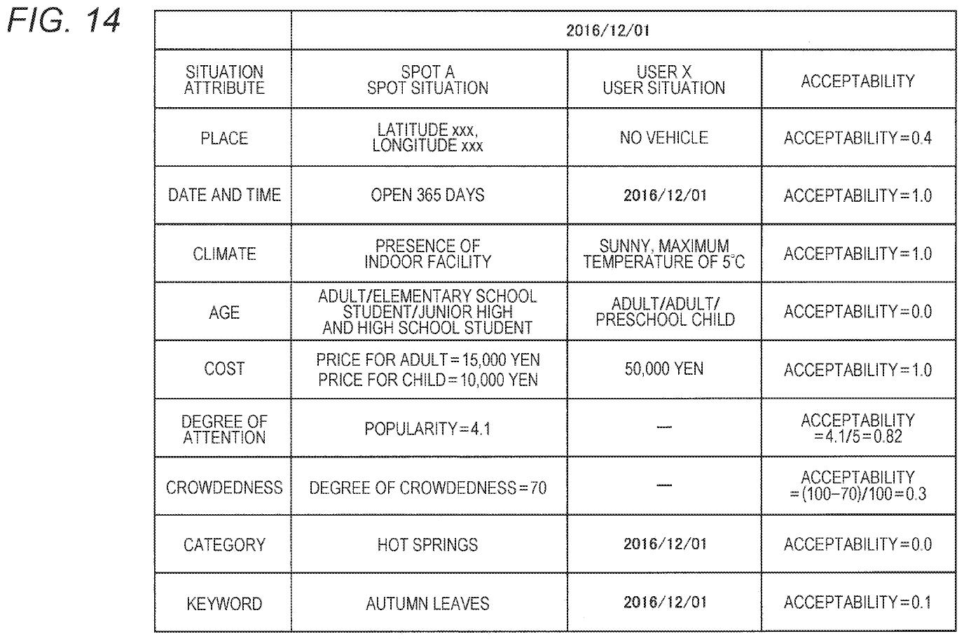

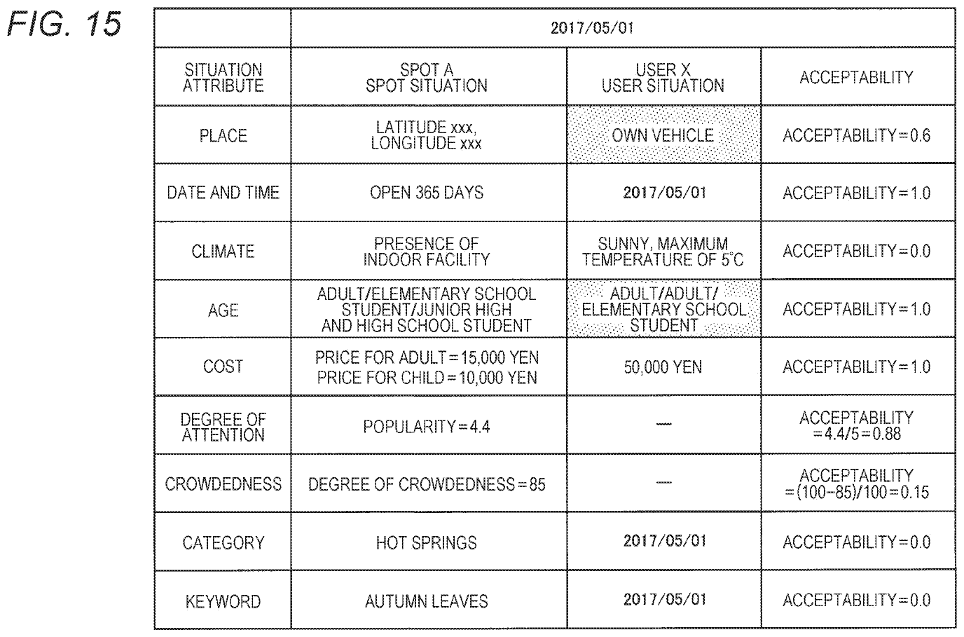

Hereinabove, the flow of calculating an acceptability score according to the present embodiment has been described in detail. Next, calculation of the acceptability score according to the present embodiment will be described by using specific examples. FIGS. 14 and 15 illustrate specific examples of calculating the acceptability score according to the present embodiment.

FIG. 14 illustrates examples of acceptability for each spot situation, user situation, and situation attribute at the time of previous calculation. Herein, in a case where a weight regarding all the situation attributes is set to 1.0, previous comprehensive acceptability can be calculated as described below.

Comprehensive acceptability=0.4*1.0+1.0*1.0+1.0*1.0+0.0*1.0+1.0*1.0+0.82*1.0+0.3*1.0+0.0*1.0+1.0*1.0=+5.52

Further, FIG. 15 illustrates examples of acceptability for each spot situation, user situation, and situation attribute at the time of current calculation. Herein, in a case where a weight regarding all the situation attributes is set to 1.0, current comprehensive acceptability can be calculated as described below.

Comprehensive acceptability=0.6*3.0+1.0*1.0+0.0*2.0+1.0*2.0+1.0*2.0+0.88*2.0+0.15*1.0+0.0*1.0+0.0*1.0=+8.71

Herein, when comparing FIGS. 14 and 15, it is found that, when the situation attribute of “place” and the situation attribute of “age” in the user situation are changed, acceptability corresponding thereto is also changed.

Specifically, because a user X possesses a vehicle, the acceptability regarding the situation attribute of “place” is changed to 0.6 (+0.2), and, because a child of the user has entered an elementary school, the acceptability regarding the situation attribute of “age” is changed to 1.0 (+1.0).

Herein, in a case where the threshold of the number of changed attributes in adopting the acceptability score is two, the recommendation unit 260 may adopt a comprehensive acceptability difference (8.71−5.52=3.19) as the final acceptability score because the two situation attributes of “place” and “age” are changed, i.e., the number of changed attributes is equal to or more than the threshold.

As described above, according to the recommendation unit 260 according to the present embodiment, it is possible to calculate an acceptability score that reflects an influence of the changed situation attributes more strongly, and achieve flexible and effective presentation of recommendation information in accordance with a change in the situation of the user.

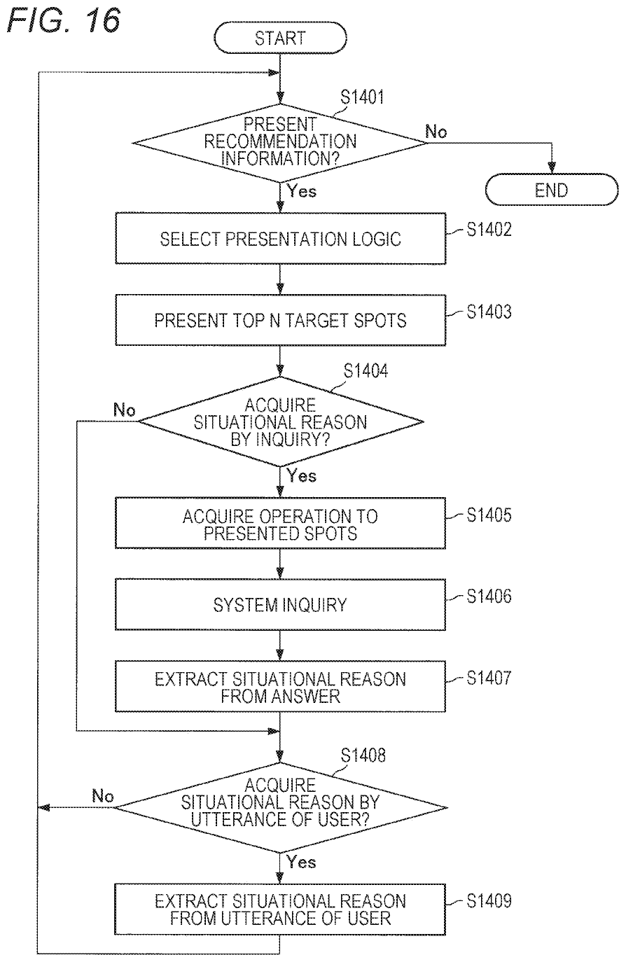

Next, a flow of presenting recommendation information and acquiring a user history regarding a situational reason according to the present embodiment will be described in detail. FIG. 16 is a flowchart showing a flow of presenting recommendation information and acquiring a user history regarding a situational reason according to the present embodiment.

When referring to FIG. 16, the recommendation unit 260 first determines whether or not to present recommendation information (S1401). At this time, the recommendation unit 260 may determine whether or not to present the recommendation information on the basis of, for example, a user session, system time, and a change in the user situation.

Herein, the above user session includes, for example, a login to the system by the user, an inquiry from the user to the system, recognition of the user by the system, and the like. The recommendation unit 260 may determine to present the recommendation information in a case where, for example, one of the above examples is detected.

Further, the above system time includes scheduled delivery, update of spot information, detection of a start of a campaign, and the like.

Further, the above change in the user situation includes, for example, addition of a family member (childbirth, marriage, and the like), growth of a child (entering school, coming of age, start doing an after-school activity, and the like), and a change in moving means (possession of a vehicle, opening of a railway to traffic, and the like). At this time, the recommendation unit 260 according to the present embodiment may determine whether or not to present the recommendation information particularly on the basis of a change in a situation attribute serving as a factor that causes reduction in an acceptability score.

More specifically, the recommendation unit 260 according to the present embodiment may determine to present the recommendation information on the basis that acceptability regarding the situation attribute is improved because of a change in the situation attribute serving as the factor that causes reduction. The above situation is expected to be, for example, an example where the child has not reached the target age previously, an example where the user has not possessed a vehicle previously, or the like.

As described above, the recommendation unit 260 according to the present embodiment can achieve more effective recommendation by presenting recommendation information to the user at a timing at which the factor that causes the reduction is solved.

In step S1401, in a case where the recommendation unit 260 determines to present the recommendation information (S1401: Yes), the recommendation unit 260 selects a presentation logic regarding presentation of the recommendation information (S1402). The recommendation unit 260 may select the presentation logic such as, for example, whether to present one of or both the recommendation results R and W.

Then, the information integration unit 300 causes the information processing terminal 10 to present top N target spots on the basis of the presentation logic selected in step S1401 (S1403).

Then, in a case where a situation is acquired by a system utterance (S1404: Yes), the recommendation unit 260 acquires a user history of the presented spots (S1405), and the positive or negative inquiry to the user as described above is executed (S1406).

Then, the recommendation unit 260 acquires a situational reason from an answer of the user to the inquiry executed in step S1406 (S1407).

Further, in a case where a situational reason based on an utterance of the user is acquired (S1408: Yes), the recommendation unit 260 extracts the situational reason from an intention of the utterance of the user on the basis of a result of voice recognition performed by the response analysis unit 280 (S1408).

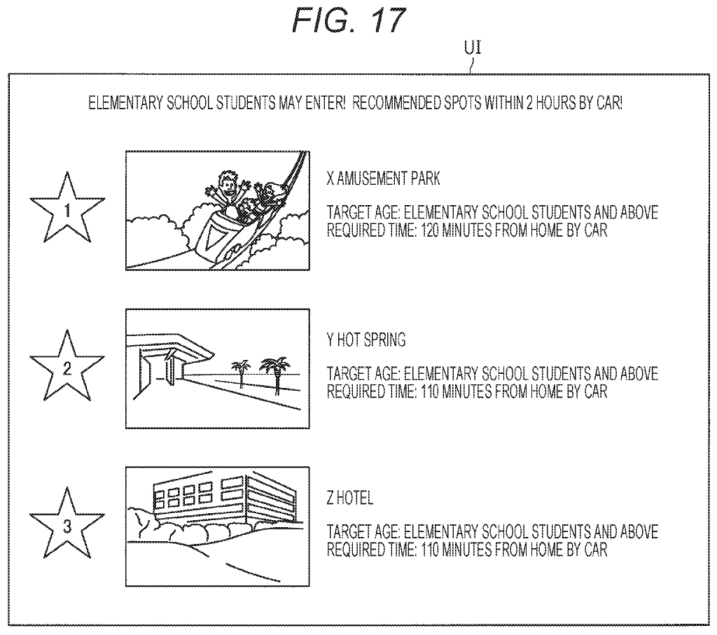

Hereinabove, the flow of the operation of the information processing server 20 according to the present embodiment has been described. FIG. 17 illustrates an example of recommendation information presented by the above flow. FIG. 17 illustrates an example of a user interface UI displayed by the display unit 110 of the information processing terminal 10.

As illustrated in FIG. 17, the user interface UI according to the present embodiment may display, in the form of rankings, recommended spots determined on the basis of the recommendation score and the acceptability score regarding the user situation. At this time, the information integration unit 300 may cause the display unit 110 to display, for example, information regarding the attribute situation serving as the solved factor that causes the reduction, while emphasizing the information.

In the example in FIG. 17, the information integration unit 300 causes the display unit 110 to display visual information including wordings such as “Elementary school students may enter.” and “within two hours by car”. According to the above control, it is possible to clearly show that options that could not have been adopted previously are selectable, i.e., options are increased because the situation has been changed, and thus it is possible to achieve more effective presentation of recommendation information.

### 1.6. Recommendation to User Individual or User Group

Next, definition of the user according to the present embodiment will be described again. As described above, the user according to the present embodiment may include both the user individual and a user group to which the user belongs.

For example, in a case where the user individual is a wife in a family, it is expected that information desired by the user individual for herself may differ from information desired for a user group, i.e., her family. Therefore, the recommendation unit 260 according to the present embodiment may calculate an acceptability score for either the user individual or the user group, and determine a ranking of a recommendation spot.

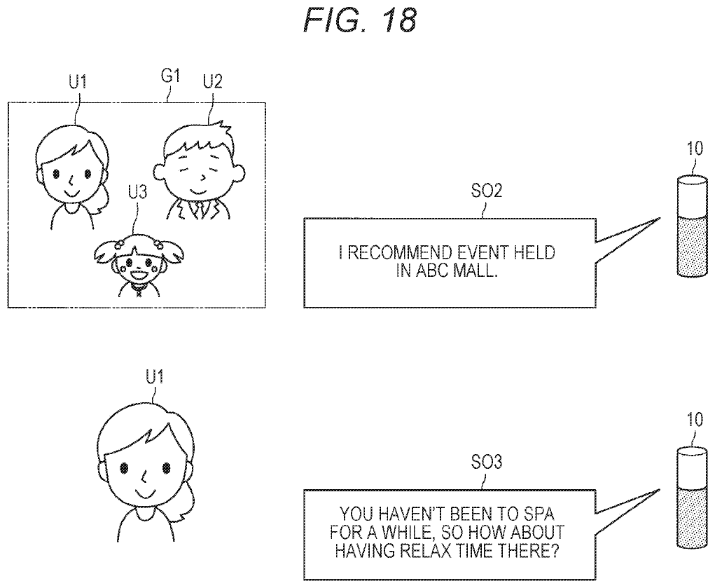

FIG. 18 is an explanatory diagram of presentation of recommendation information to a user individual or a user group according to the present embodiment.

An upper part of FIG. 18 illustrates an example where the information processing server 20 presents recommendation information to a user group G1 via the information processing terminal 10. In the example in the upper part of FIG. 18, the information processing server 20 presents recommendation information regarding an ABC mall to the user group G1 including all family members as a speech utterance SO2. Herein, the user group G1 may be a family including the user U1 who is a wife, a user U2 who is a husband, and a user U3 who is a child.

At this time, the recommendation unit 260 according to the present embodiment may give an individual ID not only to the user individual but also to the user group G1, and manage a user preference, a user history, a weight, and the like by regarding the family as a user.

Meanwhile, the recommendation unit 260 according to the present embodiment can also calculate a user preference, a user history, a weight, and the like regarding the user group G1 on the basis of a combination of the user individuals (users U1 to U3) included in the user group G1.

The recommendation unit 260 can calculate, for example, a user preference, a weight regarding a situation attribute, and the like on the basis of a sum of user histories regarding the users U1 to U3, and calculate a final acceptability score and recommendation score.

According to the above function of the recommendation unit 260, it is possible to flexibly define a plurality of user groups in a family, and it is possible to present, for example, different pieces of recommendation information to the whole family, a married couple, a mother and child, a farther and child, and the like.

Meanwhile, a lower part of FIG. 18 illustrates an example where the information processing server 20 presents recommendation information to the user U1 individual via the information processing terminal 10. In the example in the lower part of FIG. 18, the information processing server 20 presents recommendation information regarding a spa to the user U1 individual as a speech utterance SO3.

The information processing server 20 may control presentation of recommendation information to the user U1 individual on the basis that, for example, the information processing server 20 recognizes that only the user U1 exists around her, other schedules have already been registered for the users U2 and U3, or the like.

As described above, the information processing server 20 according to the present embodiment can achieve presentation of various kinds of recommendation information for both a user individual and a user group.

### 2. HARDWARE CONFIGURATION EXAMPLE

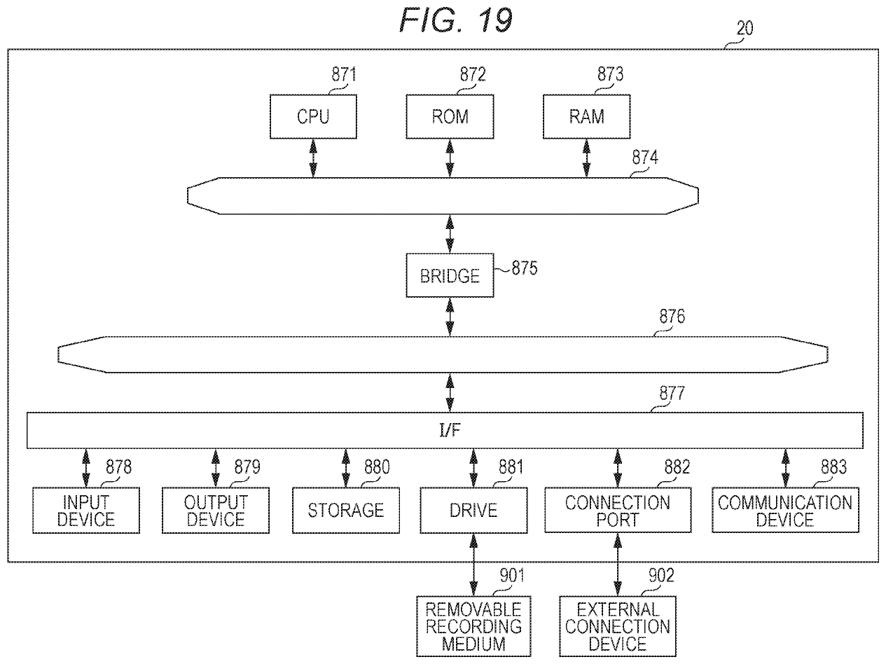

An example of the hardware configuration common to the information processing terminal 10 and the information processing server 20 according to an embodiment of the present disclosure is now described. FIG. 19 is a block diagram illustrating an example of the hardware configuration of the information processing terminal 10 and the information processing server 20 according to an embodiment of the present disclosure. When referring to FIG. 19, the information processing terminal 10 and the information processing server 20 include, for example, a CPU 871, a ROM 872, a RAM 873, a host bus 874, a bridge 875, an external bus 876, an interface 877, an input device 878, an output device 879, a storage 880, a drive 881, a connection port 882, and a communication device 883. Moreover, the hardware configuration shown here is illustrative, and some of components can be omitted. In addition, a component other than the components shown here can be further included.

### CPU 871

The CPU 871 functions as, for example, an arithmetic processing unit or a control device, and controls some or all of the operations of each component on the basis of various programs recorded in the ROM 872, the RAM 873, the storage 880, or a removable recording medium 901.

### ROM 872 and RAM 873

The ROM 872 is a means for storing programs loaded into the CPU 871, data used for operation, or the like. The RAM 873 temporarily or permanently stores, for example, a program to be loaded into the CPU 871, various parameters appropriately changing in executing the program, or the like.

### Host Bus 874, Bridge 875, External Bus 876, and Interface 877

The CPU 871, the ROM 872, and the RAM 873 are mutually connected via, for example, the host bus 874 capable of high-speed data transmission. On the other hand, the host bus 874 is connected to the external bus 876 having a relatively low data transmission rate, for example, via the bridge 875. In addition, the external bus 876 is connected to various components via the interface 877.

### Input Device 878

Examples of the input device 878 include a mouse, a keyboard, a touch panel, buttons, a switch, a lever, or the like. Furthermore, examples of the input device 878 include a remote controller capable of transmitting a control signal using infrared rays or other radio waves (hereinafter referred to as a remote controller). In addition, the input device 878 includes an audio input device such as a microphone.

### Output Device 879

The output device 879 is, for example, a device capable of visually or audibly notifying the user of the acquired information, which includes a display device such as a cathode ray tube (CRT), an LCD, or an organic EL, an audio output device such as a loudspeaker or a headphone, a printer, a mobile phone, a facsimile, or the like. In addition, the output device 879 according to the present disclosure includes various vibrating devices capable of outputting tactile stimulation.

### Storage 880

The storage 880 is a device used to store various types of data. Examples of the storage 880 include a magnetic storage device such as hard disk drives (HDDs), a semiconductor storage device, an optical storage device, a magneto-optical storage device, or the like.

### Drive 881

The drive 881 is, for example, a device that reads information recorded on the removable recording medium 901 such as a magnetic disk, an optical disk, a magneto-optical disk, or semiconductor memory or writes information to the removable recording medium 901.

### Removable Recording Medium 901

Examples of the removable recording medium 901 include a DVD medium, a Blu-ray (registered trademark) medium, an HD DVD medium, various kinds of semiconductor storage media, or the like. Of course, the removable recording medium 901 is preferably, for example, an IC card, an electronic device, or the like, mounted with a contactless IC chip.

### Connection Port 882

The connection port 882 is, for example, a port used for connection with an external connection device 902, such as a universal serial bus (USB) port, an IEEE 1394 port, a small computer system interface (SCSI), an RS-232C port, or an optical audio terminal.

### External Connection Device 902

Examples of the external connection device 902 include a printer, a portable music player, a digital camera, a digital video camera, an IC recorder, or the like.

### Communication Device 883

The communication device 883 is a communication device used for connection with a network, and examples thereof include a communication card for wired or wireless LAN, Bluetooth (registered trademark), or wireless USB (WUSB), a router for optical communication, a router for asymmetric digital subscriber line (ADSL), various communication modems, or the like.

### 3. CONCLUSION

As described above, the information processing server 20 according to the embodiment of the present disclosure includes the presentation control unit 230 that controls presentation of recommendation information to a user on the basis of a recommendation score regarding content. Further, as an aspect, the presentation control unit 230 controls presentation of the recommendation information further on the basis of an acceptability score calculated from matching between a content situation regarding the content and a user situation regarding the user. With such a configuration, it is possible to present more beneficial recommendation information at a timing suitable for a state of the user.

The preferred embodiment of the present disclosure has been described above with reference to the accompanying drawings, whilst the present disclosure is not limited to the above examples. A person skilled in the art can find various alterations and modifications within the scope of the appended claims, and it should be understood that they will naturally come under the technical scope of the present disclosure.

Further, the effects described in this specification are merely illustrative or exemplified effects, and are not limitative. That is, with or in the place of the above effects, the technology according to the present disclosure can achieve other effects that are clear to those skilled in the art from the description of this specification.

Further, the respective steps in the processing of the information processing server 20 in this specification are not necessarily executed in chronological order in accordance with the order illustrated in the flowcharts. For example, the respective steps in the processing of the information processing server 20 can be processed in the order different from the order illustrated in the flowcharts, or can also be processed in parallel.

Additionally, the present technology may also be configured as below.

(1)

An information processing apparatus including

a presentation control unit configured to control presentation of recommendation information to a user on the basis of a recommendation score regarding content, in which

the presentation control unit controls presentation of the recommendation information further on the basis of an acceptability score calculated from matching between a content situation regarding the content and a user situation regarding the user.

(2)

The information processing apparatus according to (1), in which

the presentation control unit calculates acceptability for each situation attribute included in the content situation and the user situation, and calculates the acceptability score on the basis of the acceptability for each situation attribute.

(3)

The information processing apparatus according to (2), in which

the presentation control unit calculates the acceptability score by using the acceptability for each situation attribute and a weight that is dynamically set on the basis of a situational reason obtained from a user history.

(4)

The information processing apparatus according to (3), in which

the presentation control unit uses, as the acceptability score, one of comprehensive acceptability calculated by using the acceptability and the weight and a comprehensive acceptability difference indicating a difference between the comprehensive acceptability calculated previously and the comprehensive acceptability calculated currently.

(5)

The information processing apparatus according to (4), in which

the presentation control unit selects, as the acceptability score, one of the comprehensive acceptability and the comprehensive acceptability difference on the basis of the situation attribute the acceptability of which is changed.

(6)

The information processing apparatus according to (4) or (5), in which

in a case where the number of the situation attributes the acceptability of which is changed is equal to or more than a threshold, the presentation control unit adopts the comprehensive acceptability difference as the acceptability score.

(7)

The information processing apparatus according to any one of (2) to (6), in which

the presentation control unit causes the recommendation information to be presented on the basis of a change in the situation attribute serving as a factor that causes reduction in the acceptability score.

(8)

The information processing apparatus according to (7), in which

the presentation control unit causes the recommendation information to be presented on the basis that the acceptability regarding the situation attribute serving as the factor that causes reduction is improved because of a change in the situation attribute.

(9)

The information processing apparatus according to any one of (3) to (6), in which

the presentation control unit acquires the situational reason on the basis of an utterance of the user.

(10)

The information processing apparatus according to any one of (3) to (6), in which

the presentation control unit acquires the situational reason on the basis of an answer of the user to an inquiry.

(11)

The information processing apparatus according to any one of (3) to (6), in which the presentation control unit acquires the situational reason on the basis of a tendency of the user individual based on a difference from a general model.

(12)

The information processing apparatus according to any one of (1) to (11), in which

the user includes a user individual and a user group to which the user belongs, and

the presentation control unit calculates the acceptability score by targeting one of the user individual and the user group.

(13)

The information processing apparatus according to (12), in which

the presentation control unit calculates the acceptability score on the basis of a user history regarding the user individual included in the user group.

(14)

The information processing apparatus according to any one of (1) to (13), in which

the content includes a vacation spot.

(15)

The information processing apparatus according to any one of (1) to (14), in which

the presentation control unit calculates the recommendation score on the basis of an analyzed user preference and content profile.

(16)

The information processing apparatus according to any one of (1) to (15), further including

a presentation unit configured to present the recommendation information to the user under control of the presentation control unit.

(17)

An information processing method including

causing a processor to control presentation of recommendation information to a user on the basis of a recommendation score regarding content, in which

the causing a processor to control presentation further includes

controlling presentation of the recommendation information on the basis of an acceptability score calculated from matching between a content situation regarding the content and a user situation regarding the user.

(18)

A program for causing a computer to function as an information processing apparatus including

a presentation control unit configured to control presentation of recommendation information to a user on the basis of a recommendation score regarding content, in which

the presentation control unit controls presentation of the recommendation information further on the basis of an acceptability score calculated from matching between a content situation regarding the content and a user situation regarding the user.

### REFERENCE SIGNS LIST

20 Information processing server

210 Terminal communication unit

220 Storage unit

230 Presentation control unit

240 Information collection unit

250 Information analysis unit

260 Recommendation unit

270 History management unit

280 Response analysis unit

290 Situation analysis unit

300 Information integration unit

1. An information processing apparatus comprising
a presentation control unit configured to control presentation of recommendation information to a user on a basis of a recommendation score regarding content, wherein
the presentation control unit controls presentation of the recommendation information further on a basis of an acceptability score calculated from matching between a content situation regarding the content and a user situation regarding the user.

2. The information processing apparatus according to claim 1, wherein
the presentation control unit calculates acceptability for each situation attribute included in the content situation and the user situation, and calculates the acceptability score on a basis of the acceptability for each situation attribute.

3. The information processing apparatus according to claim 2, wherein
the presentation control unit calculates the acceptability score by using the acceptability for each situation attribute and a weight that is dynamically set on a basis of a situational reason obtained from a user history.

4. The information processing apparatus according to claim 3, wherein
the presentation control unit uses, as the acceptability score, one of comprehensive acceptability calculated by using the acceptability and the weight and a comprehensive acceptability difference indicating a difference between the comprehensive acceptability calculated previously and the comprehensive acceptability calculated currently.

5. The information processing apparatus according to claim 4, wherein
the presentation control unit selects, as the acceptability score, one of the comprehensive acceptability and the comprehensive acceptability difference on a basis of the situation attribute the acceptability of which is changed.

6. The information processing apparatus according to claim 4, wherein
in a case where a number of the situation attributes the acceptability of which is changed is equal to or more than a threshold, the presentation control unit adopts the comprehensive acceptability difference as the acceptability score.

7. The information processing apparatus according to claim 2, wherein
the presentation control unit causes the recommendation information to be presented on a basis of a change in the situation attribute serving as a factor that causes reduction in the acceptability score.

8. The information processing apparatus according to claim 7, wherein
the presentation control unit causes the recommendation information to be presented on a basis that the acceptability regarding the situation attribute serving as the factor that causes reduction is improved because of a change in the situation attribute.

9. The information processing apparatus according to claim 3, wherein
the presentation control unit acquires the situational reason on a basis of an utterance of the user.

10. The information processing apparatus according to claim 3, wherein
the presentation control unit acquires the situational reason on a basis of an answer of the user to an inquiry.

11. The information processing apparatus according to claim 3, wherein
the presentation control unit acquires the situational reason on a basis of a tendency of the user individual based on a difference from a general model.

12. The information processing apparatus according to claim 1, wherein
the user includes a user individual and a user group to which the user belongs, and
the presentation control unit calculates the acceptability score by targeting one of the user individual and the user group.

13. The information processing apparatus according to claim 12, wherein
the presentation control unit calculates the acceptability score on a basis of a user history regarding the user individual included in the user group.

14. The information processing apparatus according to claim 1, wherein
the content includes a vacation spot.

15. The information processing apparatus according to claim 1, wherein
the presentation control unit calculates the recommendation score on a basis of an analyzed user preference and content profile.

16. The information processing apparatus according to claim 1, further comprising
a presentation unit configured to present the recommendation information to the user under control of the presentation control unit.

17. An information processing method comprising
causing a processor to control presentation of recommendation information to a user on a basis of a recommendation score regarding content, wherein
the causing a processor to control presentation further includes
controlling presentation of the recommendation information on a basis of an acceptability score calculated from matching between a content situation regarding the content and a user situation regarding the user.

18. A program for causing a computer to function as an information processing apparatus comprising
a presentation control unit configured to control presentation of recommendation information to a user on a basis of a recommendation score regarding content, wherein
the presentation control unit controls presentation of the recommendation information further on a basis of an acceptability score calculated from matching between a content situation regarding the content and a user situation regarding the user.
